(19) United States
(12) Patent Application Publication
(10) Pub. No.: US 2021/0154606 A1
(43) Pub. Date: May 27, 2021

(54) EFFICIENT LOW-RESISTANCE MICRO-NANO-FIBER MICROSCOPIC GRADIENT STRUCTURE FILTRATION MATERIAL, AND PREPARATION METHOD THEREFOR

(71) Applicants: South China University of Technology, Guangzhou, Guangdong (CN); Guangzhou Fiber Product Testing and Research Institute, Guangzhou, Guangdong (CN)

(72) Inventors: Yurong Yan, Guangzhou (CN); Peng Zhang, Guangzhou (CN); Ruitian Zhu, Guangzhou (CN); Yaoming Zhao, Guangzhou (CN); Lingli Deng, Guangzhou (CN); Fei Zou, Guangzhou (CN); Suhan Yang, Guangzhou (CN); Wentao Zhang, Guangzhou (CN)

(73) Assignees: South China University of Technology, Guangzhou, Guangdong (CN); Guangzhou Fiber Product Testing and Research Institute, Guangzhou, Guangdong (CN)

(21) Appl. No.: 17/047,697

(22) PCT Filed: May 16, 2018
(86) PCT No.: PCT/CN2018/087101

§ 371 Date: Oct. 15, 2020

(30) Foreign Application Priority Data
Apr. 17, 2018 (CN) 201810341627.1

(51) Int. Cl. B01D 39/16; D04H 1/541; D04H 1/544; D04H 1/545; D04H 1/548; D04H 1/549; D04H 1/55; D04H 1/559; D04H 1/728

(52) U.S. Cl. CPC B01D 39/163; D10B 2505/04; D04H 1/544; D04H 1/545; D04H 1/548; D04H 1/549; D04H 1/55; D04H 1/559; D04H 1/728; B01D 2239/1233; B01D 2239/025; B01D 2239/0435; B01D 2239/1291; B01D 2239/0654; B01D 2239/10; B01D 2239/0618; B01D 2239/0631; B01D 2239/0622; B01D 2239/0627; D04H 1/541

(57) ABSTRACT

The present invention discloses a micro gradient filter material of high-efficiency low-resistance micron-nano fibers and a preparation method therefor. The material comprises a nano fine filter layer, a micron support primary filter layer, and a protective surface layer; the micron support primary filter layer and the nano fine filter layer are alternately superimposed, and arranged between the two protective surface layers; the nano fine filter layer has a grid structure composed of a plane matrix fiber layer and cones, wherein the fibers between the point of the cone and the grid matrix fiber layer form a structure oriented from the point to the plane matrix fiber layer. In the present invention, the uncharged filter material of has a filtration efficiency of 99.9% to 99.999% and a pressure drop of 130-300 Pa for the NaCl aerosol with a mass median diameter of 0.26 μm, and the uncharged filter material has a filtration efficiency of 99.9% to 99.999% and a pressure drop of 30-250 Pa for the NaCl aerosol with a mass median diameter of 0.26 μm.

### FIELD OF THE INVENTION

The present invention relates to the field of air filtration, in particular to a gradient composite filter medium material with good filtration effect, and a preparation method therefor.

### BACKGROUND OF THE INVENTION

Air is necessary for human survival. Due to the impact of production and various other human activities, especially the large amount of arbitrary discharge of industrial waste gas, air is polluted to varying degrees due to the excessive dust and harmful gases contained therein. In recent years, PM2.5 has attracted extensive attention of the society. Dust can cause great harm to organs such as the respiratory tract and eyes. According to the “Green GDP Accounting Report”, the annual loss due to environmental pollution in Beijing alone is as high as 11.6 billion yuan, wherein air pollution causes the most serious economic loss in Beijing, reaching 9.52 billion yuan, accounting for 81.75% of the total pollution-caused loss. It can be seen from this that environmental pollution has a great impact on the economy and society, and air pollution in particular deserves more attention.

The fiber air filter materials currently on the market mainly include glass fiber, polyester fiber, polyacrylonitrile fiber, activated carbon fiber, etc. However, these fiber air filter materials, mostly having a straight-through structure, only have a high filtration efficiency for particles above 0.3 μm, and are difficult to achieve effective filtration for submicron particles and smaller particles. Traditional air filter materials have short service cycle and high filtration resistance, and can no longer fully meet people's requirements for high-efficiency filter materials.

With the development of nanotechnology, nanomaterials have replaced traditional materials more and more widely due to their unique and excellent properties, and have been applied in the fields of separation, sensors, biomedicine, and so on. The micron-nano hierarchical structure of the materials endows them with novel properties and special functions. Compared with traditional non-woven fibers, the electrospun fiber materials with a micron-nano hierarchical structure have a small fiber diameter, a small membrane pore size, and a high porosity; in addition, due to the introduction of the hierarchical structure, these materials have greatly increased specific surface area and pore volume of the fiber, enhanced adsorption and dust holding volume of the fiber membrane, and effectively improved filtration efficiency. The composite filter material with an electrospun nano fiber membrane as the interlayer is more suitable for filtering fine particles, and the combination of the nano fiber and gradient structure is more conducive to prolonging the service life of the filter material.

Chinese patent CN 103264533 A disclosed a ceramic-intermetallic compound gradient filter tube and its preparation method and application; the filter tube of this invention used Ni powder, Al powder, Ti powder, B₄C powder, SiC powder and TiH₂ as raw materials, which reacted to synthesize the inner layer that was made of porous TiC+TiB₂ ceramics with good wear resistance and corrosion resistance, the pores being filled with TiB+Ti₃B₄ whiskers with a length of 10 μm; the outermost layer of the filter tube was a porous NiAl+Ni₃Al intermetallic compound layer with high strength and good corrosion resistance; from the inside to the outside of the filter tube, the amount of the ceramic component gradually decreased, while the amount of the intermetallic compound component gradually increased, thus forming a gradient structure. The filter tube overcame the shortcomings of the existing filter materials, such as high filtration resistance, low filtration efficiency, and difficulty in washing; however, this ceramic-intermetallic compound gradient filter tube had a high cost and a complicated process, which was not conducive to the promotion and industrialization of the technology. Chinese invention patent application CN 103446804 A disclosed a carbon nanotube air filter material with a gradient structure, and a preparation method therefor; the carbon nanotube air filter material formed a gradient structure by growing carbon nanotubes with different contents on the surface of the fiber, thereby having such characteristics as high filtration efficiency and low filtration resistance. However, the carbon nanotubes were prone to agglomeration in the solution, reducing the porosity of the filter material; and the nanoparticles might fall off during use, threatening human health.

### CONTENTS OF THE INVENTION

The existing filter materials have high filtration efficiency for air, but have the disadvantages of high resistance and short service life. In order to improve this situation, the primary purpose of the present invention is to provide a high-efficiency low-resistance filter medium material with low cost, excellent filtration effect, and a three-dimensional structure, which can reduce the filtration resistance and prolong the service life of the filter materials.

Another purpose of the present invention is to provide a method for preparing the high-efficiency low-resistance filter medium material for air filtration.

Compared with the composite gradient filter material of the prior art, the composite gradient filter medium material of the present invention has a simple preparation process, has no factors affecting the fiber uniformity under the spinning conditions of the present invention, has high efficiency and low resistance, and has a micron-nano filter layer with a three-dimensional structure formed by a combination of a micron fiber layer with a crimped structure and a nano fiber layer containing a pointed cone stacking structure, thereby increasing the chance of inertial collision between the fiber and the airflow, resulting in an increase in the probability of particles being intercepted by the filter components. In addition, because the direction of the micron fibers is at a certain angle with the direction of the airflow, the resistance of the filter material to directly intercept particles is reduced; the three-dimensional structure provides a pore structure, which changes the flow direction of the airflow; the fluffier micron fiber filter layer can accommodate more filtered particles, thus greatly reducing the filtration resistance of the filter material.

The purposes of the present invention are achieved by the following technical solution:

A micro gradient filter material of high-efficiency low-resistance micron-nano fibers is provided, comprising a nano fine filter layer A, a micron support primary filter layer B, and a protective surface layer C, wherein the micron support primary filter layer and the nano fine filter layer are alternately superimposed, and arranged between the two protective surface layers;

the nano fine filter layer is composed of a plane matrix fiber layer D and cones E, wherein the fibers between the point of the cone E and the grid matrix fiber layer D form a structure oriented from the point to the plane matrix fiber layer D, the cone angle of the cone E being 10° to 70°, the distance between the cone points being 2-20 mm; a plurality of the cones E are evenly distributed on the plane matrix fiber layer D to form a grid structure;

the micron support primary filter layer B is composed of a micron fiber layer with a crimped structure; the nano fine filter layer has a grid structure;

the surface of the nano fine filter layer is charged or uncharged, and the micron support filter layer is charged or uncharged.

In order to further achieve the purposes of the present invention, preferably, the nano fiber in the nano fine filter layer has a diameter of 10-1000 nm, and a grammage of 0.5-20 g/m²; the fiber material of the micron support primary filter layer has a diameter of 1-100 μm, and a grammage of 10-200 g/m².

Preferably, the fiber material of the micron support primary filter layer obtains a non-woven fabric structure through needle punching, spunlacing, spunbonding, meltblowing, or stitching.

Preferably, the fibers of the micron fiber layer are at an angle of 10° to 50° with the horizontal plane, and have a Z-shaped, S-shaped, spiral or wavy crimped structure; when the fibers of the micron fiber layer are short fibers, they themselves have a crimped structure; when the fibers of the micron fiber layer are filaments, a crimped structure is obtained through a composite spinning process; the composite fiber obtained by the composite spinning process includes a sheath-core, eccentric core, or side-by-side structure.

Preferably, the material of the micron support primary filter layer includes polyester fiber, polypropylene fiber, polyurethane elastic fiber, polyacrylonitrile fiber, polyamide fiber, polyvinyl acetal fiber, polylactic acid fiber, acetate fiber, cellulose fiber, polycaprolactone fiber, sheath-core fiber, natural fiber, or inorganic fiber;

the sheath-core fiber includes PP/PE, PET/PE, PA/PE, PET/PA, or PET/coPET fiber, wherein PE, PA or coPET is in the sheath layer;

the natural fiber includes cotton, kapok, jute, hemp, ramie, apocynum, coir fiber, pineapple fiber, bamboo fiber, or straw fiber;

the inorganic fiber includes glass fiber, carbon fiber, boron fiber, alumina fiber, silicon carbide fiber, or basalt fiber.

Preferably, the material of the protective surface layer includes polyester fiber, polypropylene fiber, polyethylene fiber, polyamide fiber, or cellulose regenerated fiber.

Preferably, the protective surface layer is made of a non-woven fabric material obtained by spunbonding, hot rolling or hot air forming, having a grammage of 10-80 g/m².

Preferably, when the pressure drop is 130-300 Pa, the filtration efficiency of the uncharged micro gradient filter material of high-efficiency low-resistance micron-nano fibers is 99.9% to 99.999% for the NaCl aerosol with a mass median diameter of 0.26 μm; when the pressure drop is 30-250 Pa, the filtration efficiency of the charged micro gradient filter material of high-efficiency low-resistance micron-nano fibers is 99.9% to 99.999% for the NaCl aerosol with a mass median diameter of 0.26 μm, realizing high-efficiency air filtration.

A method for preparing the micro gradient filter material of high-efficiency low-resistance micron-nano fibers is provided, comprising the following steps:

1) Mixing a polymer with a solvent to prepare a polymer solution with a mass fraction of 5% to 40%, and letting the solution stand for defoaming;

2) shaping the resulting polymer solution by needle electrospinning, centrifugal spinning, needle-free free surface electrospinning, centrifugal electrospinning or meltblown electrospinning, and using a template as a receiver, so as to obtain a charged or uncharged nano fine filter layer with a grid structure; or shaping the resulting polymer solution by the freeze-drying phase separation, centrifugal spinning, needle electrospinning, needle-free free surface electrospinning, centrifugal electrospinning or meltblown electrospinning technology, using a template as a receiver, and then treating with n-hexanol, so as to obtain an uncharged nano fine filter layer with a grid structure;

3) treating the micron support primary filter layer by the electrostatic electret process of corona discharge, triboelectrification, thermal polarization or low-energy electron beam bombardment to obtain a charged micron support primary filter layer; and

4) the outer two layers of the micro gradient filter material of high-efficiency low-resistance micron-nano fibers are the protective surface layers, and the micron support primary filter layer and the nano fine filter layer are superimposed alternately; the protective surface layer, the micron support primary filter layer, the nano fine filter layer and the protective surface layer are combined by the hot air bonding technology at a temperature of 150° C. to 250° C.

Preferably, the material of the template includes plastic, ceramic, stainless steel, copper, aluminum, mica sheets, or silicon wafers; the template comprises a bottom plate and a cone array, wherein a plurality of cones are uniformly distributed on the bottom plate to form the cone array; the cones, being regular polygon or circular at the base, have a diameter or side length of 0.01-5 mm, a distribution density of 10-100 pcs/cm², and a height of 0.001-1.0 mm; a certain density of cones are distributed on the bottom plate to form a grid structure;

the polymer is one or more of polyvinylpyrrolidone (PVP), polyvinyl alcohol (PVA), and polyethylene oxide (PEO), polylactic acid (PLA), polyglycolic acid (PGA), polycaprolactone (PCL), polyacrylonitrile (PAN), polystyrene (PS), polymethyl methacrylate (PMMA), polyvinylidene fluoride (PVDF), polyvinylidene chloride (PVDC), ethylene-propylene copolymer (EPDM), polyvinyl acetate (EVA), polyethylene elastomer (EEA), polyamide (PA), and copolyamide (coPA);

the surface-charged nano fine filter layer can be obtained from the surface-uncharged nano fine filter layer by corona discharge, triboelectrification, thermal polarization, or low-energy electron beam bombardment.

In the present invention, the micron support primary filter layer is composed of a micron fiber layer with a crimped structure, and the nano fine filter layer is composed of a nano fiber layer with a pointed cone stacking structure; the filter medium material has a 3D gradient structure that, however, does not have an obvious layered gradient but a partial overlap.

Preferably, the material of the template with the grid structure includes one of plastic, ceramic, stainless steel, copper, aluminum, mica sheets, and silicon wafers. The template comprising the bottom plate and the cones exists in a stable, equidistant polygonal or circular structure; the cone has a diameter or side length of 0.01-5 mm, a distribution density of 10-100 pcs/cm², and a height of 0.001-1.0 mm.

The filter medium material is a composite material, and its process is characterized by the combination of a non-woven protective surface layer, a micron support primary filter layer and a nano fine filter layer through the hot air bonding technology at a temperature of 150° C. to 250° C., so as to prepare the composite filter material with a locally oriented 3D structure.

The two outermost upper and lower layers of the filter medium material are protective surface layers, and the filter layer of the composite medium material is composed of a micron support primary filter layer and a nano fine filter layer that are superimposed alternately.

The locally oriented 3D structure includes one of Z-shaped, S-shaped, spiral, and wavy crimped structures; for the short fiber raw material, it has a crimped structure itself; for filaments, the crimped structure is obtained by adjusting the composite spinning process; the composite fiber obtained by the composite spinning process includes a sheath-core, eccentric core, or side-by-side structure.

The micron support primary filter layer can be treated by corona discharge, triboelectrification, thermal polarization or low-energy electron beam bombardment, and the other electrostatic electret processes to obtain a charged micron support primary filter layer.

The present invention prepares a composite filter material with a locally oriented 3D structure, wherein the fibers in the nano fine filter layer have a certain degree of two-dimensional or three-dimensional orientation, and the fibers of the support primary filter layer made of micron-sized materials have a 3D network structure and a certain degree of fluffiness.

The median particle diameter is also known as the mass median aerodynamic diameter. When the total mass of particles smaller than a certain aerodynamic diameter accounts for 50% of the total mass of all particles of different sizes, this diameter is called the mass median diameter. That is, half of the particles with this median diameter have a particle size smaller than this diameter, and the other half have a particle size larger than this diameter. If there is no specific distribution information, it is difficult to define the particle size of the NaCl aerosol.

Compared with the prior art, the present invention has the following advantages and beneficial effects:

The micron-nano filter medium material with a composite gradient structure according to the present invention has a simple preparation process and a uniform pointed cone stacking structure, with the micron-nano fiber layer forming a locally oriented 3D structure; this locally oriented, hierarchical, and transitional structure-containing filter material composed of nano and micron materials can reduce the filtration resistance and extend the service life of the filter material; the air is subjected to the primary filtration of the micron fiber layer and the fine filtration of the nano fiber layer to achieve a high filtration effect; the non-woven fabric surface layer provides support and protection for the core layer filter material and improves the mechanical properties. The uncharged composite material has a filtration efficiency of 99.9% to 99.999% and a pressure drop of 130-300 Pa for the NaCl aerosol with a mass median diameter of 0.26 μm; the charged composite material has a filtration efficiency of 99.9% to 99.999% and a pressure drop of 30-250 Pa for the NaCl aerosol with a mass median diameter of 0.26 μm, effectively achieving the purpose of air filtration.

### BRIEF DESCRIPTION OF THE DRAWINGS

FIG. 1 schematically shows the structure of the high-efficiency low-resistance composite filter medium material with a gradient structure of the present invention.

FIG. 2 schematically shows the structure of the nano fine filter layer with a grid structure in FIG. 1.

FIG. 3 schematically shows the structure of the filter layer of the present invention with a partially overlapping gradient.

FIG. 4 schematically shows the structure and fiber arrangement of the fiber with a three-dimensional crimped structure in Example 1 of the present invention.

FIG. 5 schematically shows the structure of the fiber with a three-dimensional crimped structure in Example 2 of the present invention.

FIG. 6 schematically shows the structure of the fiber with a three-dimensional crimped structure in Example 3 of the present invention.

FIG. 7 schematically shows the structure of the fiber with a three-dimensional crimped structure in Example 4 of the present invention.

FIG. 8 schematically shows the structure of a receiving plate in Example 1 of the present invention.

FIG. 9 schematically shows the structure of a receiving plate in Example 2 of the present invention.

In the figures are a nano fine filter layer A, a micron support primary filter layer B, a protective surface layer C, a grid matrix fiber layer D, a cone E, and a cone angle α of the cone E.

### DETAILED DESCRIPTION OF THE EMBODIMENTS

In order to make the present invention better understood, the present invention will be further described below in conjunction with drawings and examples; however, the embodiments of the present invention are not limited thereto.

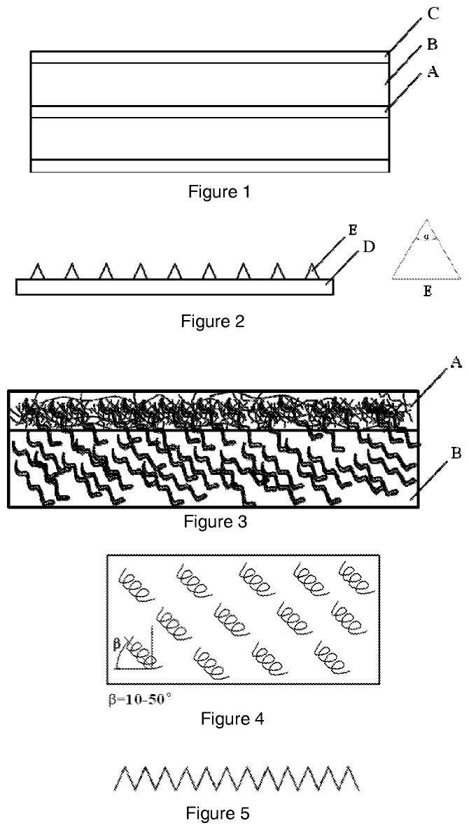

FIG. 1 schematically shows the structure of the high-efficiency low-resistance composite filter medium material with a gradient structure of the present invention. FIG. 2 schematically shows the structure of the nano fine filter layer with a grid structure in FIG. 1. A composite micro gradient filter material of high-efficiency low-resistance micron-nano fibers is provided, comprising a nano fine filter layer A, a micron support primary filter layer B, and a protective surface layer C, wherein the nano fine filter layer A and the micron support primary filter layer B are alternately superimposed and arranged between the two protective surface layers C.

The nano fine filter layer A has a grid structure composed of a plane matrix fiber layer D and cones E, wherein the fibers between the point of the cone E and the grid matrix fiber layer D form an oriented arrangement from the point to the matrix fiber layer D, the cone angle α of the cone E being 10° to 70°, the distance between the cone points being 2-20 mm; the surface of the nano fine filter layer A is charged or uncharged.

The micron support primary filter layer B is composed of a micron fiber layer with a crimped structure, wherein the micron fibers in the fiber layer form an angle β (10° to 50°) with the horizontal plane of the layer, and have a Z-shaped, S-shaped, spiral or wavy crimped structure.

Nano materials are used to prepare the fine filter layer, and micron materials are used to prepare the support primary filter layer, and then the nano fine filter layer, the micron support primary filter layer and the protective surface layer are combined by the hot air bonding technology to obtain a high-efficiency low-resistance filter medium material for air filtration.

In the micro gradient filter material of high-efficiency low-resistance micron-nano fibers of the present invention, the protective surface layer is a protective layer, the micron support primary filter layer is a primary filter layer and a dust-holding layer, and the nano fiber layer is a fine filter layer.

The micro gradient filter material of the high-efficiency low-resistance micron-nano fibers of the present invention is a high-efficiency low-resistance filter medium material with a three-dimensional structure; the nano fine filter layer is a nano fiber layer with a pointed cone stacked structure; the support filter layer is composed of micron fibers, and forms a gradient perpendicular to the surface layer of the filter material, with the gradient not having an obvious layered gradient but a partial overlap.

The grid structure in the template is formed by the distribution of cones at a certain density on the bottom plate, while the grid structure in the nano fine filter layer is given by the template with the grid structure.

### Example 1

Drying PVA (M_{w}=2.5×10⁵ g/mol) in vacuum (50 □, 12 h), then adding deionized water as a solvent, and stirring for 2 h after heating to 80° C. to obtain a uniform PVA solution with a mass concentration of 10%, and finally letting the PVA solution stand for defoaming for 4 h.

As shown in FIGS. 1-3, a nano fine filter layer A, which had no charge on the surface of PVA, was prepared from the PVA solution by the needleless free surface electrospinning method. In forming, the distance between the receiving plate and the solution tank was about 25 cm, the voltage was about 60 kV, and the speed of the rotor wrapped with wire to form a wire electrode in the solution tank was 70 r/min. The receiving plate, as shown in FIG. 8, was made of plastic, and comprised a bottom plate and cones; a plurality of cones were evenly distributed on the bottom plate with a distribution density of 50 pcs/cm²; the base of the cone was circular with a diameter F of 4 mm, and the height of the template cone was 0.001 mm. The obtained nano fine filter layer A had a grid structure, and the surface of the PVA was not charged; as shown in FIG. 2, there was an oriented fiber structure between the point of the cone E and the grid matrix fiber layer D, wherein the cone angle of the cone E was 40°, and the distance between the cone points was 10 mm; the nano fibers of the PVA fine filter layer had a diameter of 100-200 nm, and a grammage of 10 g/m².

In the micron support primary filter layer B, the non-woven fabric material was obtained from the polylactic acid fibers with a spiral structure as shown in FIG. 4 by needle punching; in the non-woven fabric material, the diameter of the polylactic acid fiber was 20-50 μm, the angle β between the axial direction of the fiber and the surface of the cloth substrate was 20°, and the grammage was 100 g/m²; then the charged micron support primary filter layer B was obtained through the corona discharge electret process.

In forming, the non-woven fabric material, obtained from the polylactic acid fibers with a spiral structure by needle punching, was provided on the receiving plate as shown in FIG. 8, and then the nano fine filter layer with an uncharged PVA surface was received and superimposed thereupon; then a cellulose regenerated fiber spunbonded non-woven fabric with a grammage of 40 g/m² was provided on the upper and lower ends of the obtained material; the above four layers were combined by the hot air bonding technology at a temperature of 180° C. to prepare a composite filter material with a locally oriented 3D structure; in addition, there was a partially overlapping gradient between the micron support primary filter layer and the fine filter layer in the filter material (as shown in FIG. 3), thus obtaining a high-efficiency low-resistance filter medium material for air filtration.

The TSI 8130 automatic filter material tester of TSI company of USA was used to test the filtration performance of the filter material; when the pressure drop was 110 Pa, the filtration efficiency of the charged composite filter medium material obtained in this example was 99.99% for the NaCl aerosol with a mass median diameter of 0.26 μm; for the PAN microsphere/nano fiber composite membrane with a three-dimensional cavity structure also prepared by free surface electrospinning, the pressure drop was 126.7 Pa when the filtration efficiency reached 99.99% (Gao H, Yang Y, Akampumuza O, et al. Low filtration resistance three-dimensional composite membrane fabricated via free surface electrospinning for effective PM2.5 capture[J]. Environmental Science Nano, 2017, 4(4)). This showed that the micron support primary filter layer in the filter material had an increased fluffiness of the filter material and a stronger effect of reducing the pressure drop compared with the microsphere/nano fiber composite filter layer.

With the continuous filter loading time of the filter material of the present invention being 30 min, when the micron support primary filter layer B was on the windward side, the pressure drop increased from 110 Pa to 369 Pa; when the nano fine filter layer A was on the windward side, the pressure drop increased from 110 Pa to 581 Pa. This showed that the micron support primary filter layer of the micron-nano fiber filter material with a gradient structure could greatly reduce the rate of resistance rise and had a longer service life.

Compared with the composite gradient filter material of the prior art, this composite gradient filter medium material had a simple preparation process, high efficiency, and low resistance; the micron-nano filter layer with a 3D structure formed by the combination of a micron fiber layer with a crimped structure and a nano fiber layer containing a pointed cone stacking structure increased the chance of inertial collision between the fiber and the airflow, resulting in an increase in the probability of particles being intercepted by the filter components. In addition, because the direction of the micron fibers was at a certain angle with the direction of the airflow, the resistance of the filter material to directly intercept particles was reduced; the three-dimensional structure provided a pore structure, which changed the flow direction of the airflow; the fluffier micron fiber filter layer structure could accommodate more filtered particles, thus greatly reducing the filtration resistance of the filter material.

### Example 2

Drying PLA (M_{w}=6.0×10⁵ g/mol) in vacuum (60 □, 10 h) and keeping it ready for use.

As shown in FIGS. 1-3, a nano fine filter layer A, which was charged on the surface of PLA, was prepared from the PLA solution by the meltblown electrospinning method. In forming, the distance between the receiving plate and the meltblown electrostatic spinneret was about 20 cm, the voltage was about 60 kV, and the PLA melt had a flow rate of 0.3 cc/min for meltblown electrospinning. The receiving plate, being a stainless steel belt, had a receiving surface (as shown in FIG. 9), which comprised a bottom plate and cones; a plurality of cones were evenly distributed on the bottom plate with a distribution density of 60 pcs/cm²; the base of the cone was square with a side length F of 1.41 mm, and the height of the template cone was 0.002 mm. The obtained nano fine filter layer A had a grid structure, and the surface of the PLA was charged; as shown in FIG. 2, there was an oriented fiber structure between the point of the cone E and the grid matrix fiber layer D, wherein the cone angle of the cone E was 50°, and the distance between the cone points was 15 mm; the nano fibers of the PLA fine filter layer had a diameter of 400-800 nm, and a grammage of 20 g/m².

In the micron support primary filter layer B, the non-woven fabric material was obtained from the polyester fibers with a Z-shaped crimped structure as shown in FIG. 5 by the spunlace method; in the non-woven fabric material, the diameter of the polyester fiber was 2-10 μm, the angle β between the axial direction of the fiber and the surface of the cloth substrate was 45°, and the grammage was 50 g/m²; then the charged micron support primary filter layer B was obtained through the triboelectrification process.

In forming, the non-woven fabric material, obtained from the polyester fibers with the Z-shaped crimped structure by spunlacing, was provided on the template as shown in FIG. 9, and then the nano fine filter layer with a charged PLA surface was received and superimposed thereupon; then the non-woven fabric material, obtained from the polyester fibers with the Z-shaped crimped structure by spunlacing, was superimposed on the nano fine filter layer with a charged PLA surface; then a polypropylene fiber meltblown non-woven fabric with a grammage of 20 g/m² was provided on the upper and lower ends of the obtained material; the above five layers were combined by the hot air bonding technology at a temperature of 180° C. to prepare a composite filter material with a locally oriented 3D structure; in addition, there was a partially overlapping gradient between the micron support primary filter layer and the fine filter layer in the filter material, thus obtaining a high-efficiency low-resistance filter medium material for air filtration.

The TSI 8130 automatic filter material tester of TSI company of USA was used to test the filtration performance of the filter material; when the pressure drop was 60 Pa, the filtration efficiency of the charged composite filter medium material obtained in this example was 99.9% for the NaCl aerosol with a mass median diameter of 0.26 μm, enabling effective air filtration.

### Example 3

Drying PCL (M_{w}=1.2×10⁶ g/mol) in vacuum (50 □, 8 h), then adding dimethylacetamide as a solvent, and stirring for 2 h after heating to 60° C. to obtain a uniform PCL solution with a mass concentration of 15%, and finally letting the PCL solution stand for defoaming for 3 h.

As shown in FIGS. 1-3, a nano fine filter layer A, which was charged on the surface of PCL, was prepared from the PCL solution by the double needle electrospinning method. In forming, the distance between the receiving plate and the needle was about 12 cm, the voltage was about 15 kV, and the PCL solution had a flow rate of 0.5 mL/h for electrospinning. The receiving plate, being a silicon wafer, was a circular grid with a grid diameter of 0.04 mm, a density of 80 pcs/cm², and a height of 0.02 mm. The obtained nano fine filter layer A had a grid structure, and the surface of the PCL was charged; as shown in FIG. 2, there was an oriented fiber structure between the point of the cone E and the grid matrix fiber layer D, wherein the cone angle of the cone E was 60°, and the distance between the cone points was 12 mm; the nano fibers of the PCL fine filter layer had a diameter of 80-300 nm, and a grammage of 4 g/m².

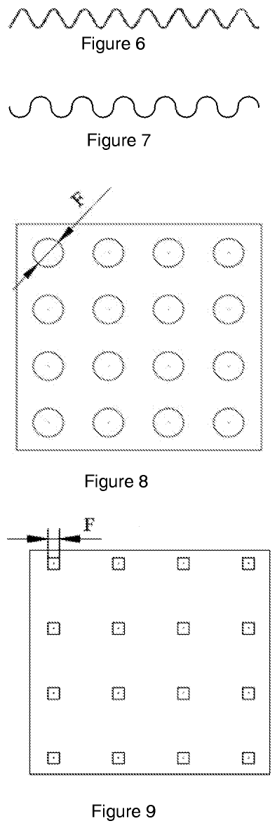

In the micron support primary filter layer B, the non-woven fabric material was obtained from the polypropylene fibers with a spiral crimped structure as shown in FIG. 6 by spunbonding; in the non-woven fabric material, the diameter of the polypropylene fiber was 20-40 μm, the angle between the axial direction of the fiber and the surface of the cloth substrate was 25°, and the grammage was 120 g/m²; then the charged micron support primary filter layer was obtained through the corona discharge electret process.

In forming, the non-woven fabric material, obtained from the polypropylene fibers with a spiral crimped structure by spunbonding, was provided on the template, and then the nano fine filter layer with charged PCL surface was received and superimposed thereupon; then a cellulose regenerated fiber spunbonded non-woven fabric with a grammage of 60 g/m² was provided on the upper and lower ends of the obtained material; the above four layers were combined by the hot air bonding technology at a temperature of 150° C. to prepare a composite filter material with a locally oriented 3D structure; in addition, there was a partially overlapping gradient between the micron support primary filter layer and the fine filter layer in the filter material, thus obtaining a high-efficiency low-resistance filter medium material for air filtration.

The TSI 8130 automatic filter material tester of TSI company of USA was used to test the filtration performance of the filter material; when the pressure drop was 40 Pa, the filtration efficiency of the charged composite filter medium material obtained in this example was 99.97% for the NaCl aerosol with a mass median diameter of 0.26 μm, enabling effective air filtration.

### Example 4

Drying PA (M_{w}=3.5×10⁵ g/mol) in vacuum (70 □, 12 h), then adding formic acid as a solvent, and stirring for 2 h after heating to 70° C. to obtain a uniform PA solution with a mass concentration of 10%, and finally letting the PA solution stand for defoaming for 4 h.

As shown in FIGS. 1-3, a nano fine filter layer A, which was uncharged on the surface of PA, was prepared from the PA solution by the single needle electrospinning method and being treated with n-hexanol. In forming, the distance between the receiving plate and the needle was about 10 cm, the voltage was about 10 kV, and the PA solution had a flow rate of 0.3 mL/h for electrospinning. The receiving plate, being made of stainless steel, was a hexagonal grid with a grid side length of 0.5 mm, a density of 60 pcs/cm², and a height of 0.01 mm. The obtained nano fine filter layer A had a grid structure, and the surface of the PA was not charged; as shown in FIG. 2, there was an oriented fiber structure between the point of the cone E and the grid matrix fiber layer D, wherein the cone angle of the cone E was 55°, and the distance between the cone points was 16 mm; the nano fibers of the PA fine filter layer had a diameter of 100-250 nm, and a grammage of 15 g/m².

In the micron support primary filter layer B, the non-woven fabric material was obtained from the polyurethane elastic fibers with an S-shaped crimped structure as shown in FIG. 7 by the meltblowing method; in the non-woven fabric material, the diameter of the polyurethane fiber was 25-40 μm, the angle between the axial direction of the fiber and the surface of the cloth substrate was 30°, and the grammage was 90 g/m², thus obtaining the uncharged micron support primary filter layer.

In forming, the non-woven fabric material, obtained from the polyurethane elastic fibers with an S-shaped crimped structure by the meltblowing method, was provided on the template, and then the nano fine filter layer with an uncharged PA surface was received and superimposed thereupon; then a polyester fiber hot air non-woven fabric with a grammage of 20 g/m² was provided on the upper and lower ends of the obtained material; the above four layers were combined by the hot air bonding technology at a temperature of 200° C. to prepare a composite filter material with a locally oriented 3D structure; in addition, there was a partially overlapping gradient between the micron support primary filter layer and the fine filter layer in the filter material, thus obtaining a high-efficiency low-resistance filter medium material for air filtration.

The TSI 8130 automatic filter material tester of TSI company of USA was used to test the filtration performance of the filter material; when the pressure drop was 200 Pa, the filtration efficiency of the uncharged composite filter medium material obtained in this example was 99.99% for the NaCl aerosol with a mass median diameter of 0.26 μm, enabling effective air filtration.

### Example 5

Drying PS (M_{w}=3.0×10⁵ g/mol) in vacuum (50 □, 12 h), then adding DMF as a solvent, and stirring for 1 h after heating to 80° C. to obtain a uniform PS solution with a mass concentration of 15%, and finally letting the PA solution stand for defoaming for 4 h.

As shown in FIGS. 1-3, a nano fine filter layer A, which was uncharged on the surface of PS, was prepared from the PS solution by the centrifugal electrospinning method and being treated with n-hexanol. In forming, the distance between the receiving plate and the needle was about 10 cm, the voltage was about 20 kV, and the centrifugal spinning speed was 350 r/min. The receiving plate, being made of plastic, was a circular grid with a grid diameter of 0.5 mm, a density of 80 pcs/cm², and a height of 0.3 mm. The obtained nano fine filter layer A had a grid structure, and the surface of the PS was not charged; as shown in FIG. 2, there was an oriented fiber structure between the point of the cone E and the grid matrix fiber layer D, wherein the cone angle of the cone E was 20°, and the distance between the cone points was 15 mm; the nano fibers of the PS fine filter layer had a diameter of 200-500 nm, and a grammage of 4 g/m². The PS nano fine filter layer with no charge on the surface was subjected to corona discharge treatment to obtain a surface-charged PS nano fine filter layer.

In the micron support primary filter layer B, the non-woven fabric material was obtained from the polypropylene fibers with an S-shaped crimped structure by spunbonding; in the non-woven fabric material, the diameter of the polypropylene fiber was 10-25 μm, the angle between the axial direction of the fiber and the surface of the cloth substrate was 50°, and the grammage was 120 g/m²; then the charged micron support and primary filter composite layer was obtained through the thermal polarization process.

In forming, the non-woven fabric material, obtained from the polypropylene fibers with an S-shaped crimped structure by spunbonding, was provided on the template, and then the nano fine filter layer with charged PS surface was received and superimposed thereupon; then the non-woven fabric material, obtained from the polypropylene fibers with the S-shaped crimped structure by spunbonding, was superimposed on the nano fine filter layer with a charged PS surface; then a polyamide fiber spunbonded non-woven fabric with a grammage of 50 g/m² was provided on the upper and lower ends of the obtained material; the above five layers were combined by the hot air bonding technology at a temperature of 200° C. to prepare a composite filter material with a locally oriented 3D structure; in addition, there was a partially overlapping gradient between the micron support primary filter layer and the fine filter layer in the filter material, thus obtaining a high-efficiency low-resistance filter medium material for air filtration.

The TSI 8130 automatic filter material tester of TSI company of USA was used to test the filtration performance of the filter material; when the pressure drop was 230 Pa, the filtration efficiency of the charged composite filter medium material obtained in this example was 99.999% for the NaCl aerosol with a mass median diameter of 0.26 μm, enabling effective air filtration.

### Example 6

Drying PEO (M_{w}=2.0×10⁶ g/mol) in vacuum (50 □, 10 h), then adding water as a solvent, and stirring for 2 h after heating to 60° C. to obtain a uniform PEO solution with a mass concentration of 5%, and finally letting the PEO solution stand for defoaming for 5 h.

As shown in FIGS. 1-3, a nano fine filter layer A, which was charged on the surface of PEO, was prepared from the PEO solution by the double needle electrospinning method. In forming, the distance between the receiving plate and the needle was about 12 cm, the voltage was about 15 kV, and the PEO solution had a flow rate of 0.5 mL/h for electrospinning. The receiving plate, being a mica sheet, was a circular grid with a grid diameter of 0.6 mm, a density of 70 pcs/cm², and a height of 0.005 mm. The obtained nano fine filter layer A had a grid structure, and the surface of the PEO was not charged; as shown in FIG. 2, there was an oriented fiber structure between the point of the cone E and the grid matrix fiber layer D, wherein the cone angle of the cone E was 50°, and the distance between the cone points was 8 mm; the nano fibers of the PEO fine filter layer had a diameter of 100-300 nm, and a grammage of 2 g/m².

In the micron support primary filter layer B, the non-woven fabric material was obtained from the polyvinyl formal fiber with a Z-shaped crimped structure and the PP/PE sheath-core fiber (the mass ratio of PP to PE was 50:50, and the mass ratio of the polyvinyl formal fiber to the PP/PE sheath-core fiber was 80:20) by the spunlace method; in the non-woven fabric material, the diameter of the polyvinyl formal fiber was 15-30 μm, the diameter of the PP/PE sheath-core fiber was 10-25 μm, the angle between the axial direction of the fiber and the surface of the cloth substrate was 20°, and the grammage was 60 g/m², thus obtaining the uncharged micron support primary filter layer.

In forming, the non-woven fabric material, obtained from the polyvinyl formal fiber with a Z-shaped crimped structure and the PP/PE sheath-core fiber (the mass ratio of PP to PE was 50:50, and the mass ratio of the polyvinyl formal fiber to the PP/PE sheath-core fiber was 80:20) by the spunlace method, was provided on the template, then the nano fine filter layer with uncharged PEO surface was received and superimposed; then a polypropylene fiber hot air non-woven fabric with a grammage of 50 g/m² was provided on the upper and lower ends of the obtained material; the above four layers were combined by the hot air bonding technology at a temperature of 150° C. to prepare a composite filter material with a locally oriented 3D structure; in addition, there was a partially overlapping gradient between the micron support primary filter layer and the fine filter layer in the filter material, thus obtaining a high-efficiency low-resistance filter medium material for air filtration.

The TSI 8130 automatic filter material tester of TSI company of USA was used to test the filtration performance of the filter material; when the pressure drop was 140 Pa, the filtration efficiency of the uncharged composite filter medium material obtained in this example was 99.9% for the NaCl aerosol with a mass median diameter of 0.26 μm, enabling effective air filtration.

The embodiments of the present invention are not limited to the above examples, and any other alterations, modifications, replacements, combinations and simplifications made without departing from the spirit and principle of the present invention shall be equivalent substitutions and included in the scope of protection of the present invention.

1. A micro gradient filter material of high-efficiency low-resistance micron-nano fibers, characterized in that: the material comprises a nano fine filter layer (A), a micron support primary filter layer (B), and a protective surface layer (C); the micron support primary filter layer and the nano fine filter layer are alternately superimposed, and arranged between the two protective surface layers;
the nano fine filter layer is composed of a plane matrix fiber layer (D) and cones (E); the fibers between the point of the cone (E) and the grid matrix fiber layer (D) form a oriented structure from the point to the plane matrix fiber layer (D), the cone angle of the cone (E) being 10° to 70°, the distance between the cone points being 2-20 mm; a plurality of the cones (E) are evenly distributed on the plane matrix fiber layer (D) to form a grid structure;
the micron support primary filter layer (B) is composed of a micron fiber layer with a crimped structure; the nano fine filter layer has a grid structure; the surface of the nano fine filter layer is charged or uncharged, and the micron support filter layer is charged or uncharged.

2. The micro gradient filter material of high-efficiency low-resistance micron-nano fibers according to claim 1, characterized in that: the nano fiber in the nano fine filter layer has a diameter of 10-1000 nm, and a grammage of 0.5-20 g/m²; the fiber material of the micron support primary filter layer has a diameter of 1-100 μm, and a grammage of 10-200 g/m².

3. The micro gradient filter material of high-efficiency low-resistance micron-nano fibers according to claim 1, characterized in that: the fiber material of the micron support primary filter layer obtains a non-woven fabric structure through needle punching, spunlacing, spunbonding, meltblowing, or stitching.

4. The micro gradient filter material of high-efficiency low-resistance micron-nano fibers according to claim 1, characterized in that: the fibers of the micron fiber layer are at an angle of 10° to 50° with the horizontal plane, and have a Z-shaped, S-shaped, spiral or wavy crimped structure; when the fibers of the micron fiber layer are short fibers, they themselves have a crimped structure; when the fibers of the micron fiber layer are filaments, a crimped structure is obtained through a composite spinning process; the composite fiber obtained by the composite spinning process includes a sheath-core, eccentric core, or side-by-side structure.

5. The micro gradient filter material of high-efficiency low-resistance micron-nano fibers according to claim 1, characterized in that: the material of the micron support primary filter layer includes polyester fiber, polypropylene fiber, polyurethane elastic fiber, polyacrylonitrile fiber, polyamide fiber, polyvinyl acetal fiber, polylactic acid fiber, acetate fiber, cellulose fiber, polycaprolactone fiber, sheath-core fiber, natural fiber, or inorganic fiber;
the sheath-core fiber includes PP/PE, PET/PE, PA/PE, PET/PA, or PET/coPET fiber, wherein PE, PA or coPET is in the sheath layer;
the natural fiber includes cotton, kapok, jute, hemp, ramie, apocynum, coir fiber, pineapple fiber, bamboo fiber, or straw fiber;
the inorganic fiber includes glass fiber, carbon fiber, boron fiber, alumina fiber, silicon carbide fiber, or basalt fiber.

6. The micro gradient filter material of high-efficiency low-resistance micron-nano fibers according to claim 1, characterized in that: the material of the protective surface layer includes polyester fiber, polypropylene fiber, polyethylene fiber, polyamide fiber, or cellulose regenerated fiber.

7. The micro gradient filter material of high-efficiency low-resistance micron-nano fibers according to claim 1, characterized in that: the protective surface layer is made of a non-woven fabric material obtained by spunbonding, hot rolling or hot air forming, having a grammage of 10-80 g/m².

8. The micro gradient filter material of high-efficiency low-resistance micron-nano fibers according to claim 1, characterized in that: when the pressure drop is 130-300 Pa, the filtration efficiency of the micro gradient filter material of the uncharged high-efficiency low-resistance micron-nano fibers is 99.9% to 99.999% for the NaCl aerosol with a mass median diameter of 0.26 μm; when the pressure drop is 30-250 Pa, the filtration efficiency of the micro gradient filter material of the charged high-efficiency low-resistance micron-nano fibers is 99.9% to 99.999% for the NaCl aerosol with a mass median diameter of 0.26 μm, realizing high-efficiency air filtration.

9. A method for preparing the micro gradient filter material of high-efficiency low-resistance micron-nano fibers according to claim 1, characterized in that: the method comprises the following steps:
1) mixing a polymer with a solvent to prepare a polymer solution with a mass fraction of 5% to 40%, and letting the solution stand for defoaming;
2) shaping the resulting polymer solution by needle electrospinning, centrifugal spinning, needle-free free surface electrospinning, centrifugal electrospinning or meltblown electrospinning, and using a template as a receiver, so as to obtain a charged or uncharged nano fine filter layer with a grid structure; or shaping the resulting polymer solution by freeze-drying phase separation, centrifugal spinning, needle electrospinning, needle-free free surface electrospinning, centrifugal electrospinning or meltblown electrospinning technology, using a template as a receiver, and then treating with n-hexanol, so as to obtain an uncharged nano fine filter layer with a grid structure;
3) treating the micron support primary filter layer by the electrostatic electret process of corona discharge, triboelectrification, thermal polarization or low-energy electron beam bombardment to obtain a charged micron support primary filter layer; and
4) the outer two layers of the micro gradient filter material of high-efficiency low-resistance micron-nano fibers are the protective surface layers, and the micron support primary filter layer and the nano fine filter layer are superimposed alternately; the protective surface layer, the micron support primary filter layer, the nano fine filter layer and the protective surface layer are combined by the hot air bonding technology at a temperature of 150° C. to 250° C.

10. The method for preparing the micro gradient filter material of high-efficiency low-resistance micron-nano fibers according to claim 9, characterized in that: the material of the template includes plastic, ceramic, stainless steel, copper, aluminum, mica sheets, or silicon wafers; the template comprises a bottom plate and a cone array, wherein a plurality of cones are uniformly distributed on the bottom plate to form the cone array; the cones, being regular polygon or circular at the base, have a diameter or side length of 0.01-5 mm, a distribution density of 10-100 pieces/cm², and a height of 0.001-1.0 mm; a certain density of cones are distributed on the bottom plate to form a grid structure;
the polymer is one or more of polyvinylpyrrolidone, polyvinyl alcohol, polyethylene oxide, polylactic acid, polyglycolic acid, polycaprolactone, polyacrylonitrile, polystyrene, polymethyl methacrylate, polyvinylidene fluoride, polyvinylidene chloride, ethylene-propylene copolymer, polyvinyl acetate, polyethylene elastomer, polyamide, and copolyamide.
